(19) United States
(12) Patent Application Publication
(10) Pub. No.: US 2026/0161040 A1
(43) Pub. Date: Jun. 11, 2026

(54) ELECTRONIC DEVICE

(71) Applicant: InnoLux Corporation, Hsinchu Science Park (TW)

(72) Inventors: Po-Sheng CHENG, Hsinchu Science Park (TW); Hong-Kang CHANG, Hsinchu Science Park (TW); Tsan-Chu LU, Hsinchu Science Park (TW)

(21) Appl. No.: 19/385,585

(22) Filed: Nov. 11, 2025

(30) Foreign Application Priority Data
Dec. 11, 2024 (CN) 202411817207.8

(51) Int. Cl. G02F 1/1676; G02F 1/1362; G02F 1/167

(52) U.S. Cl. CPC G02F 1/1676; G02F 1/136286; G02F 1/167

(57) ABSTRACT

An electronic device includes: a substrate structure including: a substrate; a first conductive layer disposed on the substrate and including a first common electrode line extending along a first direction; a second conductive layer disposed on the first conductive layer and including a second common electrode line extending along a second direction different from the first direction, wherein the first common electrode line and the second common electrode line are partially overlapped in a normal direction of the substrate, the second common electrode line has a first part and a second part, and a width of the first part is greater than a width of the second part in the first direction; and a pixel electrode, wherein at least a part of the pixel electrode is disposed on the second conductive layer, and the pixel electrode and the second common electrode line are partially overlapped.

### CROSS-REFERENCE TO RELATED APPLICATIONS

This application claims the benefits of the Chinese Patent Application Ser. No. 202411817207.8, filed on Dec. 11, 2024, the subject matter of which is incorporated herein by reference.

### BACKGROUND

### Field

The present disclosure relates to an electronic device. More specifically, the present disclosure relates to an electronic device with a common electrode line.

### Description of Related Art

With the advancement of science and technology, display technology is also constantly improving, and consumers are more and more particular about display quality, which leads to various manufacturers devoting themselves to improving the development of display quality of electronic devices to meet consumers' requirements for display quality.

When the resistance value of the common electrode line is too high, it is easy to affect the stability of signal transmission, thereby causing the display quality to deteriorate. Therefore, it is currently urgent to provide an electronic device to improve the previous defects.

### SUMMARY

The present disclosure provides an electronic device, comprising: a substrate structure, comprising: a substrate; a first conductive layer disposed on the substrate and comprising a first common electrode line extending along a first direction; a second conductive layer disposed on the first conductive layer and comprising a second common electrode line extending along a second direction different from the first direction, wherein the first common electrode line and the second common electrode line are partially overlapped in a normal direction of the substrate, wherein the second common electrode line has a first part and a second part, and a width of the first part is greater than a width of the second part in the first direction; and a pixel electrode, wherein at least part of the pixel electrode is disposed on the second conductive layer, and the pixel electrode and the second common electrode line are partially overlapped in the normal direction of the substrate.

Other novel features of the disclosure will become more apparent from the following detailed description when taken in conjunction with the accompanying drawings.

### BRIEF DESCRIPTION OF DRAWINGS

FIG. 1 is a top schematic view of a substrate structure according to one embodiment of the present disclosure.

FIG. 2A and FIG. 2B are top schematic views of a part of a substrate structure according to one embodiment of the present disclosure.

FIG. 2C is a cross-sectional schematic view of FIG. 2A along the line A-A′.

FIG. 3A to FIG. 3C are top schematic views of a part of a substrate structure according to one embodiment of the present disclosure.

FIG. 3D is a cross-sectional schematic view of FIG. 3A along the line B-B′.

FIG. 4 is an equivalent circuit diagram according to one embodiment of the present disclosure.

FIG. 5 is a schematic view of an electronic device according to one embodiment of the present disclosure.

FIG. 6 is a schematic view of an electronic device according to one embodiment of the present disclosure.

### DETAILED DESCRIPTION

The following is specific embodiments to illustrate the implementation of the present disclosure. Those who are familiar with this technique can easily understand the other advantages and effects of the present disclosure from the content disclosed in the present specification. The present disclosure can also be implemented or applied by other different specific embodiments, and various details in the present specification can also be modified and changed according to different viewpoints and applications without departing from the spirit of the present disclosure.

It should be noted that, in the present specification, when a component is described to have an element, it means that the component may have one or more of the elements, and it does not mean that the component has only one of the element, except otherwise specified. Furthermore, the ordinals recited in the specification and the claims such as “first”, “second” and so on are intended only to describe the elements claimed and imply or represent neither that the claimed elements have any proceeding ordinals, nor that sequence between one claimed element and another claimed element or between steps of a manufacturing method. The use of these ordinals is merely to differentiate one claimed element having a certain designation from another claimed element having the same designation.

In the specification and the appended claims of the present disclosure, certain words are used to refer to specific elements. Those skilled in the art should understand that electronic device manufacturers may refer to the same components by different names. The present specification does not intend to distinguish between elements that have the same function but have different names. In the following description and claims, words such as “comprising”, “including”, “containing”, and “having” are open-ended words, so they should be interpreted as meaning “containing but not limited to . . . ”. Therefore, when the terms “comprising”, “including”, “containing” and/or “having” are used in the description of the present disclosure, they specify the existence of corresponding features, regions, steps, operations and/or components, but do not exclude the existence of one or more corresponding features, regions, steps, operations and/or components.

The terms, such as “about”, “substantially”, or “approximately”, are generally interpreted as within 10%, 5%, 3%, 2%, 1%, or 0.5% of a given value or range. The quantity given here is an approximate quantity, that is, without specifying “about”, “approximately”, “substantially” and “approximately”, “about”, “approximately”, “substantially” and “approximately” can still be implied. Furthermore, when a value is “in a range from a first value to a second value” or “in a range between a first value and a second value”, the value can be the first value, the second value, or another value between the first value and the second value.

In the present specification, except otherwise specified, the terms (including technical and scientific terms) used herein have the meanings generally known by a person skilled in the art. It should be noted that, except otherwise specified, in the embodiments of the present disclosure, these terms (for example, the terms defined in the generally used dictionary) should have the meanings identical to those known in the art, the background of the present disclosure or the context of the present specification, and should not be read by an ideal or over-formal way.

In addition, relative terms such as “below” or “under” and “on”, “above” or “over” may be used in the embodiments to describe the relative relationship between one element and another element in the drawings. It will be understood that if the device in the drawing was turned upside down, elements described on the “lower” side would then become elements described on the “upper” side. When a unit (for example, a layer or a region) is referred to as being “on” another unit, it can be directly on the another unit or there may be other units therebetween. Furthermore, when a unit is said to be “directly on another unit”, there is no unit therebetween. Moreover, when a unit is said to be “on another unit”, the two have a top-down relationship in a top view, and the unit can be disposed above or below the another unit, and the top-bottom relationship depends on the orientation of the device.

In the present disclosure, the thickness, the length, the width, or the distance and angle between elements may be measured by using an optical microscope (OM), scanning electron microscope (SEM), film thickness profiler (a-step), ellipsometer, or other suitable methods. More specifically, according to some embodiments, a scanning electron microscope can be used to obtain a cross-sectional image of the structure and measure the thickness, length, width of each element or the distance and angle between elements. Furthermore, any two values or directions used for comparison may have a certain error. If the first value is equal to the second value, it implies that there may be an error of about 10% between the first value and the second value. If the first direction is perpendicular to the second direction, the angle between the first direction and the second direction May be between 80° and 100°. If the first direction is parallel to the second direction, the angle between the first direction and the second direction may be between 0° and 10°.

The embodiments of the present disclosure can be understood in conjunction with the drawings, and the drawings of the present disclosure are also considered as a part of the disclosure. It should be understood that the drawings of the present disclosure are not drawn to scale, and in fact, the sizes of elements may be arbitrarily enlarged or reduced in order to clearly illustrate the features of the present disclosure.

It should be noted that the technical solutions provided in the following different embodiments can be replaced, combined or mixed with each other to form another embodiment without violating the spirit of the present disclosure.

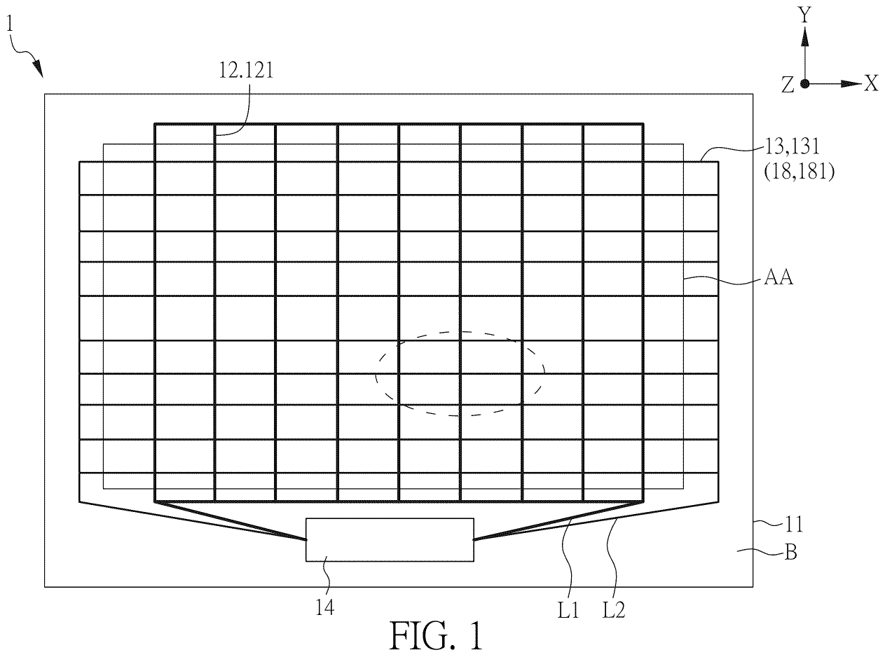

FIG. 1 is a top schematic view of a substrate structure according to one embodiment of the present disclosure.

In one embodiment of the present disclosure, the electronic device may comprise a substrate structure 1. As shown in FIG. 1, the substrate structure 1 may comprise: a substrate 11; a first conductive layer 12 disposed on the substrate 11 and comprising a first common electrode line 121; and a second conductive layer 13 disposed on the first conductive layer 12 and comprising a second common electrode line 131, wherein the first common electrode line 121 and the second common electrode line 131 are partially overlapped in a normal direction Z of the substrate 11.

In one embodiment of the present disclosure, as shown in FIG. 1, the substrate structure 1 may comprise a circuit component 14 disposed on the peripheral region B of the substrate 11. For example, the circuit component 14 may be an integrated circuit (IC). The circuit component 14 may be electrically connected to the first common electrode line 121 and the second common electrode line 131, thereby transmitting common signals to the first common electrode line 121 and the second common electrode line 131. In one embodiment of the present disclosure, as shown in FIG. 1, the substrate structure 1 may comprise an active region AA and a peripheral region B surrounding the active region AA. In the active region AA, the first common electrode line 121 may extend along a first direction Y, and the second common electrode line 131 may extend along a second direction X different from the first direction Y. For example, the first direction Y may be perpendicular to the second direction X, but the present disclosure is not limited thereto. The circuit component 14 may be disposed in the peripheral region B. In one embodiment of the present disclosure, as shown in FIG. 1, the first conductive layer 12 may comprise a plurality of first common electrode lines 121, which may be electrically connected to the circuit component 14 through conductive lines L1 disposed in the peripheral region B. Similarly, the second conductive layer 13 may comprise a plurality of second common electrode lines 131, which may be electrically connected to the circuit component 14 through conductive lines L2 disposed in the peripheral region B, but the present disclosure is not limited thereto. In other embodiments, even not shown in the figure, the plurality of first common electrode lines 121 and/or the plurality of second common electrode lines 131 may be electrically connected to the circuit component 14 directly, and not through the conductive lines L1 and/or the conductive lines L2. According to some embodiments, at least part of the plurality of first common electrode lines 121 are disposed in the active region AA, and at least part of the plurality of second common electrode lines 131 are disposed in the active region AA.

According to other embodiments, even not shown in the figure, the circuit component 14 may not be disposed on the substrate 11, but disposed outside the substrate 11.

The present disclosure can reduce the wiring resistance through the configuration of the first common electrode lines 121 and the second common electrode lines 131, thereby achieving the effect of stabilizing the signal. Hereinafter, detail features of the first common electrode lines 121 and the second common electrode line 131 are described below.

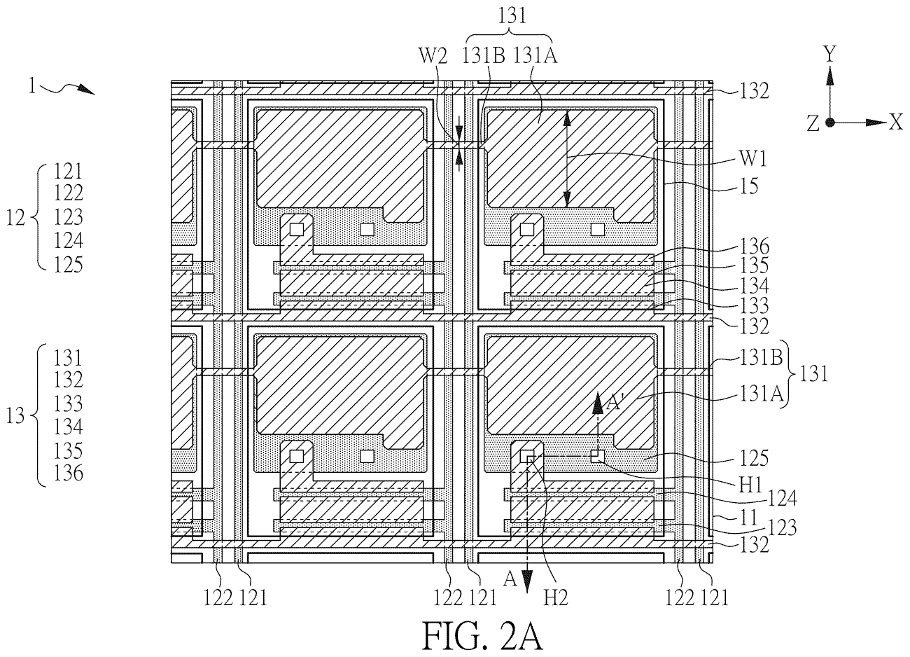

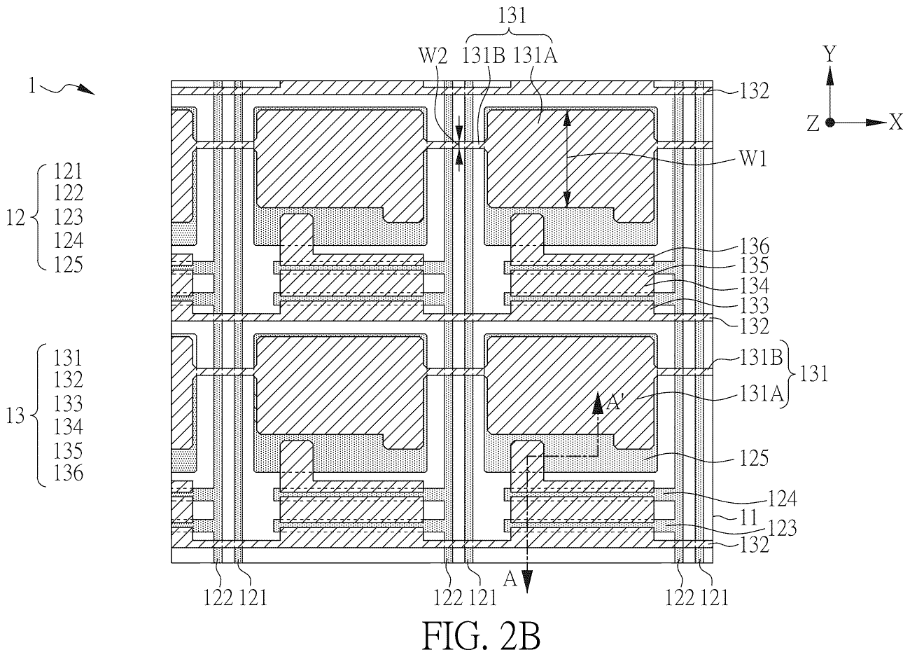

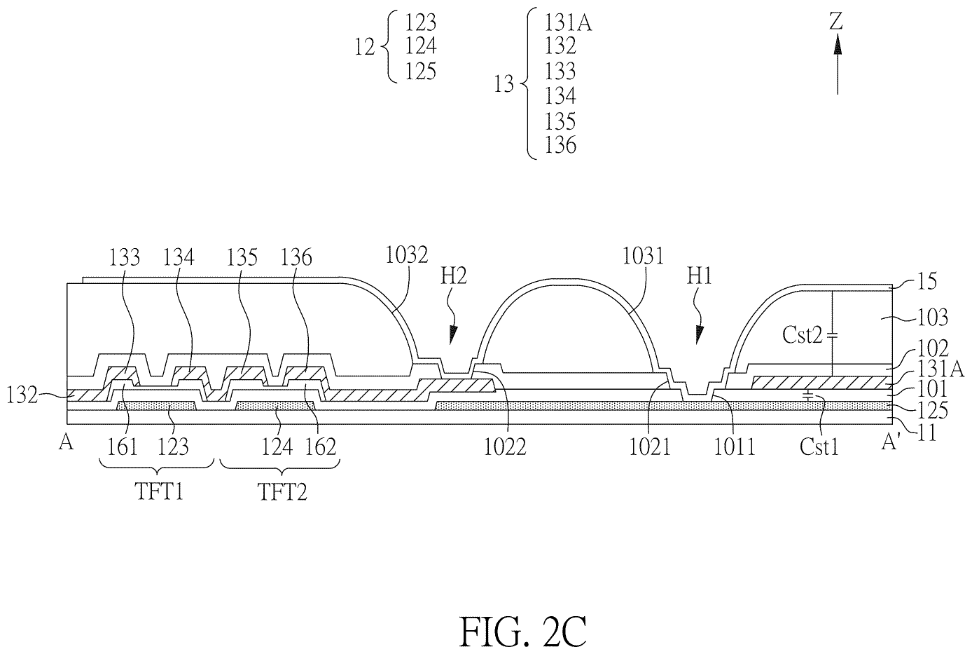

FIG. 2A and FIG. 2B are top schematic views of a part of a substrate structure according to one embodiment of the present disclosure. FIG. 2C is a cross-sectional schematic view of FIG. 2A along the line A-A′. FIG. 2A and FIG. 2B can be viewed as partial enlarged views of FIG. 1 (e.g., the dotted line in FIG. 1), and FIG. 2A and FIG. 2B are the same views. But, for the convenience of explanation, some components are omitted in FIG. 2B. FIG. 2A shows the pixel electrode 15, while FIG. 2B does not show the pixel electrode 15.

In one embodiment of the present disclosure, as shown in FIG. 2A and FIG. 2B, the second common electrode line 131 has a first part 131A and a second part 131B, and a width W1 of the first part 131A is greater than a width W2 of the second part 131B in the first direction Y. According to some embodiments, as shown in FIG. 2A, the width W1 of the first part 131A may be a minimum width of the first part 131A, and the width W2 of the second part 131B may be a minimum width of the second part 131B. According to some embodiments, the width W1 of the first part 131A may be measured at the center of the first part 131A, and the width W2 of the second part 131B may be measured at the center of the second part 131B. According to some embodiments, the width W2 of the second part 131B can be measured at the portion overlapping with the gate line 122. According to some embodiments, the width W2 of the second part 131B may be measured at a portion overlapping with the first common electrode line 121.

More specifically, the second common electrode line 131 may comprise a plurality of first parts 131A and a plurality of second parts 131B, and the first parts 131A and the second parts 131B are alternately disposed and connected to each other. That is, in the second common electrode line 131, the arrangement order in the second direction X is . . . the first part 131A, the second part 131B, the first part 131A, the second part 131B and so on. As shown in FIG. 2A, in the second direction X, one first part 131A is disposed between and connected to two adjacent second parts 131B. In the second direction X, one second part 131B is disposed between and connected to two adjacent first parts 131A. The first part 131A may be referred to as the enlarged part, and an area of the first part 131A is greater than an area of the second part 131B. Compared with the second part 131B, the width of the first part 131A in the first direction Y is greater. In one embodiment of the present disclosure, as shown in FIG. 2A, in the normal direction Z of the substrate 11, the first common electrode line 121 and the second part 131B of the second common electrode line 131 are at least partially overlapped. In other words, in the normal direction Z of the substrate 11, the first common electrode line 121 extending along the first direction Y and the second part 131B of the second common electrode line 131 (the second part 131B extending along the second direction X) are arranged to cross each other.

In one embodiment of the present disclosure, as shown in FIG. 2A and FIG. 2C, the substrate structure 1 may further comprise a pixel electrode 15, and at least part of the pixel electrode 15 is disposed on the second conductive layer 13. In the normal direction Z of the substrate 11, the pixel electrode 15 and the second common electrode line 131 are partially overlapped. More specifically, in the normal direction Z of the substrate 11, a part of the pixel electrode 15 and the first part 131A of the second common electrode line 131 are overlapped.

In one embodiment of the present disclosure, as shown in FIG. 2A and FIG. 2B, the first conductive layer 12 further comprises a gate line 122 extending along the first direction Y, wherein the gate line 122 and the first common electrode line 121 are electrically insulated. The first conductive layer 12 further comprises a first gate electrode 123 and a second gate electrode 124 extending along the second direction X respectively, wherein the first gate electrode 123 and the second gate electrode 124 are electrically connected to the gate line 122. The gate line 122 may transmit gate signals to the first gate electrode 123 and the second gate electrode 124. As shown in FIG. 2A, the second part 131B of the second common electrode line 131 extending along the second direction X may also be arranged to cross the gate line 122. The first conductive layer 12 may comprise a plurality of first common electrode lines 121 and a plurality of gate lines 122. In the second direction X, the first common electrode lines 121 and the gate lines 122 may be alternately disposed. In other words, one gate line 122 may be disposed between two first common electrode lines 121. The gate line 122 may be electrically connected to a gate driver (not shown in the figure), which may provide signals to the gate lines 122 and may be disposed in the peripheral region B (as shown in FIG. 1).

In one embodiment of the present disclosure, as shown in FIG. 2A and FIG. 2B, the second conductive layer 13 further comprises a data line 132 extending along the second direction X, wherein the data line 132 is electrically insulated from the second common electrode line 131. The second conductive layer 13 may further comprise a first source electrode 133, a first drain electrode 134, a second source electrode 135 and a second drain electrode 136, wherein the first source electrode 133 is electrically connected to the data line 132, and the second drain electrode 136 is electrically connected to the pixel electrode 15. The data line 132 may transmit data signals to the first source electrode 133. As shown in FIG. 2A and FIG. 2B, the data line 132 extending along the second direction X may be arranged to cross the first common electrode line 121 and the gate line 122. The second conductive layer 13 may comprise a plurality of second common electrode lines 131 and a plurality of data lines 132. In the first direction Y, the second part 131B of the second common electrode line 131 and the data line 132 may be alternately disposed. In other words, one data line 132 may be disposed between the second parts 131B of two second common electrode lines 131. The data line 132 may be electrically connected to a data driver (not shown in the figure), which may provide signals to the data lines 132 and may be disposed in the peripheral region B (as shown in FIG. 1).

In one embodiment of the present disclosure, as shown in FIG. 2C, the substrate structure 1 further comprises a first semiconductor 161 and a second semiconductor 162 disposed on the first conductive layer 12, wherein the first source electrode 133 and the first drain electrode 134 are electrically connected to the first semiconductor 161, and the second source electrode 135 and the second drain electrode 136 are electrically connected to the second semiconductor 162. The first gate electrode 123, the first source electrode 133, the first drain electrode 134 and the first semiconductor 161 may form a first transistor TFT1, the second gate electrode 124, the second source electrode 135, the second drain electrode 136 and the second semiconductor 162 may form a second transistor TFT2. In one embodiment of the present disclosure, the first transistor TFT1 can be connected in series with the second transistor TFT2. More specifically, the first drain electrode 134 may extend and connect to the second source electrode 135, thereby electrically connecting the first transistor TFT1 and the second transistor TFT2. The transistors in the figure are only examples and the present invention is not limited thereto. According to some embodiments, the number of transistors in the substrate structure 1 is not particularly limited, and may comprise one transistor or more than one transistor. As shown in FIG. 2C, the first conductive layer 12 (or the first gate electrode 123) is disposed between the substrate 11 and the first semiconductor 161 to form a bottom gate type transistor. According to other embodiments, even not shown in the figure, the first semiconductor 161 may be disposed between the substrate 11 and the first conductive layer 12 (or the first gate electrode 123) to form a top gate type transistor.

In one embodiment of the present disclosure, as shown in FIG. 2A and FIG. 2B, the first conductive layer 12 may further comprise a conductive bump 125, wherein the conductive bump 125 and the first common electrode line 121 are electrically insulated. In one embodiment of the present disclosure, as shown in FIG. 2A and FIG. 2C, the pixel electrode 15 may be electrically connected to the conductive bump 125 through a first via H1. More specifically, the substrate structure 1 may comprise: a first insulating layer 101 disposed on the first conductive layer 12; a second insulating layer 102 disposed on the second conductive layer 13; and a third insulating layer 103 disposed on the second insulating layer 102, wherein the first insulating layer 101 comprises a via 1011, the second insulating layer 102 comprises a via 1021, the third insulating layer 103 comprise a via 1031, the via 1011, the via 1021 and the via 1031 form the first via H1, and the pixel electrode 15 is electrically connected to the conductive bump 125 through the first via H1. According to some embodiments, the substrate structure 1 may not have the conductive bump 125 and the first via H1, and the pixel electrode 15 does not need to be directly connected to the first conductive layer 12. According to some embodiments, as shown in FIG. 2A, the pixel electrode 15 may not be overlapped with the first common electrode line 121. Alternatively, according to some embodiments, even not shown in the figure, the pixel electrode 15 may be partially overlapped with the first common electrode line 121.

In one embodiment of the present disclosure, as shown in FIG. 2A and FIG. 2C, the pixel electrode 15 may be electrically connected to the second drain electrode 136 through a second via H2. More specifically, the second insulating layer 102 comprises a via 1022, the third insulating layer 103 comprises a via 1032, the via 1022 and the via 1032 form the second via H2, and the pixel electrode 15 is electrically connected to the second drain electrode 136 through the second via H2.

In one embodiment of the present disclosure, as shown in FIG. 2A to FIG. 2C, in the normal direction Z of the substrate 11, the conductive bump 125 and the second common electrode line 131 are partially overlapped to form a first capacitor Cst1, and the pixel electrode 15 and the second common electrode line 131 are partially overlapped to form a second capacitor Cst2, wherein the overlapping portions of the conductive bump 125 and the second common electrode line 131 may be used as the capacitor electrodes of the first capacitor Cst1 respectively, and the overlapping portions of the pixel electrode 15 and the second common electrode line 131 may be used as the capacitor electrodes of the second capacitor Cst2 respectively.

In the present disclosure, the substrate 11 may be a rigid substrate or a flexible substrate, and suitable material may comprise glass, quartz, sapphire, ceramics, organic materials, inorganic materials, polycarbonate (PC), polyimide (PI), polypropylene (PP), polyethylene terephthalate (PET), polymethylmethacrylate (PMMA), other suitable materials or a combination thereof, but the present disclosure is not limited thereto.

In the present disclosure, the materials of the first conductive layer 12 and the second conductive layer 13 may respectively comprise a suitable metal material, such as gold, silver, copper, palladium, platinum, ruthenium, aluminum, cobalt, nickel, titanium, molybdenum, manganese, tungsten, an alloy thereof or a combination thereof, but the present disclosure is not limited thereto. In the present disclosure, the material of the pixel electrode 15 may comprise a transparent conductive material, such as indium zinc oxide (IZO), indium tin oxide (ITO), indium tin zinc oxide (ITZO), indium gallium zinc oxide (IGZO), aluminum zinc oxide (AZO) or a combination thereof, but the present disclosure is not limited thereto.

In the present disclosure, the materials of the first semiconductor 161 and the second semiconductor 162 may respectively comprise amorphous silicon, polycrystalline silicon (e.g., low temperature polycrystalline silicon (LTPS)), or oxide semiconductors, such as metal oxides (e.g., indium gallium zinc oxide (IGZO), indium gallium oxide (IGO), indium tin zinc oxide (ITZO), or indium gallium tin zinc oxide (IGTZO)), but the present disclosure is not limited thereto. In one embodiment of the present disclosure, the first semiconductor 16 and the second semiconductor 162 may selectively comprise a doping carrier, such as an N-type carrier or a P-type carrier to form an N-doped semiconductor or a P-doped semiconductor, but the present disclosure is not limited thereto.

In the present disclosure, the materials of the first insulating layer 101, the second insulating layer 102 and the third insulating layer 103 may respectively comprise an inorganic material, an organic material or a combination thereof. For example, the first insulating layer 101, the second insulating layer 102 and the third insulating layer 103 may respectively comprise silicon nitride, silicon oxide, silicon oxynitride, silicon carbonitride, aluminum oxide or a combination thereof, but the present disclosure is not limited thereto. Suitable organic materials comprise acrylic acid, polyimide, benzocyclobutene-based resin, acrylate-based resin or a combination thereof, but the present disclosure is not limited thereto.

As mentioned above, in the present disclosure, through the common electrode lines extending in different directions, the resistance value of the common electrode lines can be reduced, thereby achieving the effect of stable signal transmission. More specifically, the first common electrode line 121 extends along the first direction Y, and the second common electrode line 131 extends along the second direction X, thus the resistance of the wiring can be reduced and the effect of stabilizing the signal transmission can be achieved, thereby improving the display quality of the electronic device.

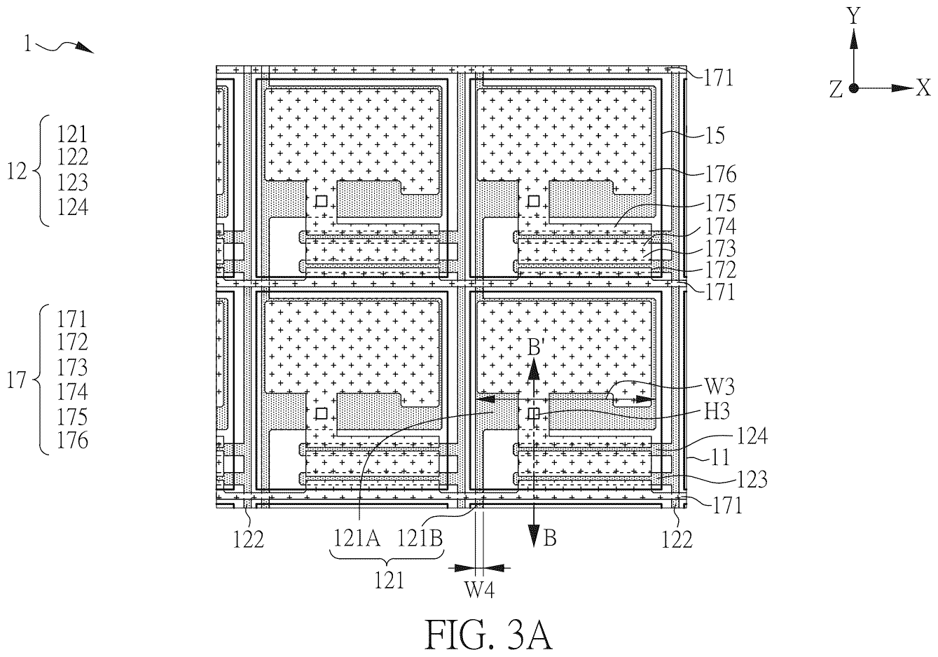

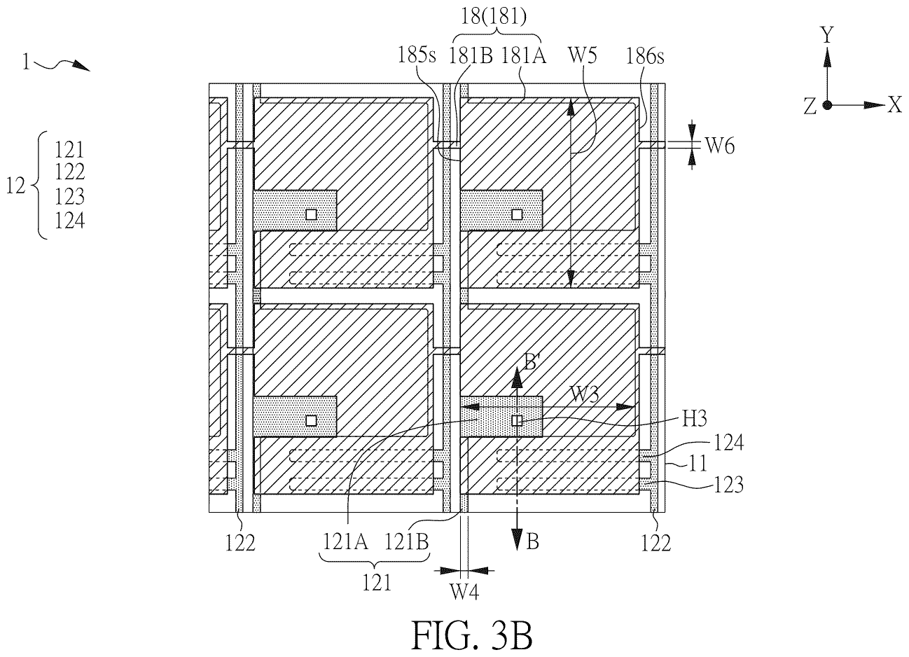

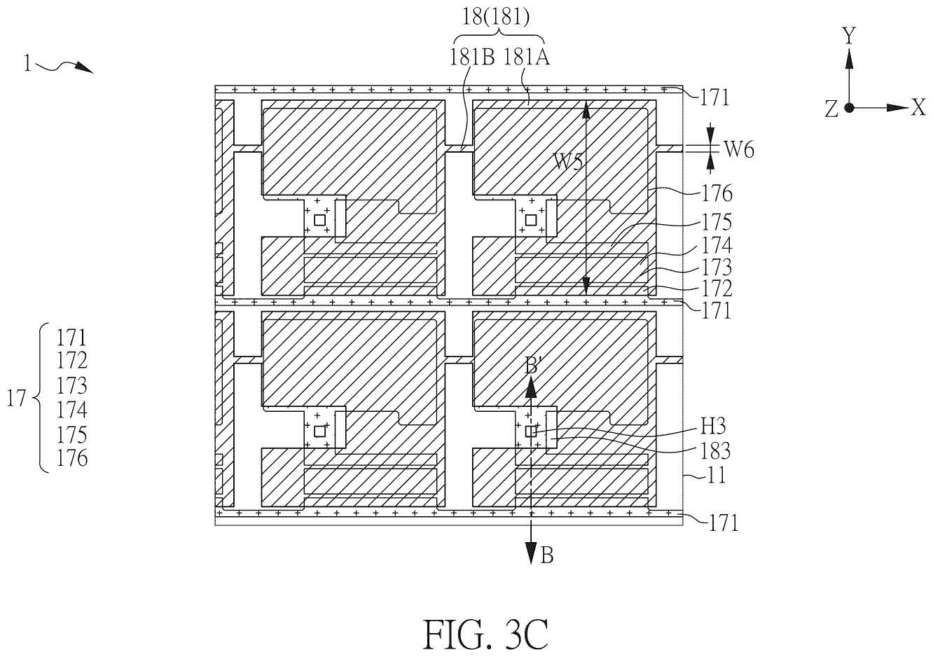

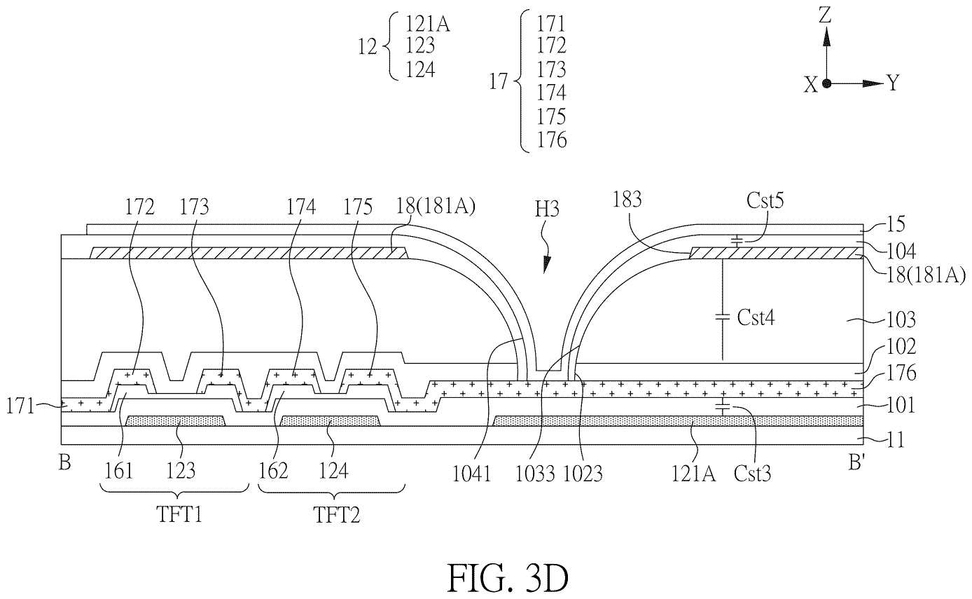

FIG. 3A to FIG. 3C are top schematic views of a part of a substrate structure according to one embodiment of the present disclosure. FIG. 3D is a cross-sectional schematic view of FIG. 3A along the line B-B′. FIG. 3A to FIG. 3C can be viewed as partially enlarged views of FIG. 1 (e.g., the dotted line in FIG. 1), and FIG. 3A to FIG. 3C are the same. But, for the convenience of description, some elements are omitted in FIG. 3A to FIG. 3C.

As shown in FIG. 3A and FIG. 3D, the substrate structure 1 further comprises a third conductive layer 17 disposed between the first conductive layer 12 and the second conductive layer 18. For convenience of explanation, FIG. 3A only shows the first conductive layer 12 and the third conductive layer 17, and the second conductive layer 18 is not shown in the figure. For convenience of explanation, FIG. 3B only shows the first conductive layer 12 and the second conductive layer 18, and the third conductive layer 17 is not shown in the figure. For convenience of explanation, FIG. 3C only shows the second conductive layer 18 and the third conductive layer 17, and the first conductive layer 12 is not shown in the figure. FIG. 3A and FIG. 3D show the pixel electrode 15, but FIG. 3B and FIG. 3C do not show the pixel electrode 15.

In one embodiment of the present disclosure, as shown in FIG. 3B to FIG. 3D, the second common electrode line 181 has a first part 181A and a second part 181B. In the first direction Y, the width W5 of the first part 181A is greater than the width W6 of the second part 181B. According to some embodiments, as shown in FIG. 3B, the width W5 of the first part 181A may be the minimum width of the first part 181A, and the width W6 of the second part 181B may be the minimum width of the second part 181B. According to some embodiments, the width W5 of the first part 181A may be measured at the center of the first part 181A, and the width W6 of the second part 181B may be measured at the center of the second part 181B. According to some embodiments, the width W6 of the second part 181B may be measured at the portion overlapping with the gate line 122.

More specifically, the second common electrode line 181 comprise a plurality of first parts 181A and a plurality of second parts 181B, and the first parts 181A and the second parts 181B are alternately disposed and connected to each other. That is, in the second common electrode line 181, the arrangement order in the second direction X is . . . the first part 181A, the second part 181B, the first part 181A, the second part 181B . . . and so on. As shown in FIG. 3B, in the second direction X, one first part 181A is disposed between and connected to two adjacent second parts 181B. In the second direction X, one second part 181B is disposed between and connected to two adjacent first parts 181A. The first part 181A may be referred to as an enlarged part, and the area of the first part 181A is greater than the area of the second part 181B. Compared with the second part 181B, the width of the first part 181A in the first direction Y is greater.

In one embodiment of the present disclosure, as shown in FIG. 3A and FIG. 3B, the first common electrode line 121 has a third part 121A and a fourth part 121B. In the second direction X, the width W3 of the third part 121A is greater than the width W4 of the fourth part 121B. According to some embodiments, as shown in FIG. 3A, the width W3 of the third part 121A may be the minimum width of the third part 121A, and the width W4 of the fourth part 121B may be the minimum width of the fourth part 121B. According to some embodiments, the width W3 of the third part 121A may be measured at the center of the third part 121A, and the width W4 of the fourth part 121B may be measured at the center of the fourth part 121B. Even not shown in FIG. 3B According to some embodiments, the width of the first part 181A in the second direction X may be smaller than that shown in FIG. 3B. More specifically, along the second direction X, the first part 181A comprises two opposite sides 185s, 186s. The side 185s may be separated from the fourth part 121B of the first common electrode line 121. That is, the first part 181A of the second common electrode line 181 and the fourth part 121B of the first common electrode line 121 may not be overlapped, and the second part 181B of the second common electrode line 181 and the fourth part 121B of the first common electrode line 121 may be overlapped. In this situation, the width W6 of the second part 181B of the second common electrode line 181 may be measured at a portion overlapping the fourth part 121B of the first common electrode line 121.

More specifically, as shown in FIG. 3A, the first common electrode line 121 comprises a plurality of third parts 121A and a plurality of fourth parts 121B alternately disposed and connected to each other. That is, in the first common electrode line 121, the arrangement order in the first direction Y is . . . the third part 121A, the fourth part 121B, the third part 121A, the fourth part 121B . . . and so on. As shown in FIG. 3A, in the first direction Y, one third part 121A is disposed between and connected to two adjacent fourth parts 121B. In the first direction Y, one fourth part 121B is disposed between and connected to two adjacent third parts 121A. The third part 121A may be referred to as an enlarged part, and the area of the third part 121A is greater than the area of the fourth part 121B. Compared with the fourth part 121B, the width of the third part 121A in the second direction X is greater. In one embodiment of the present disclosure, as shown in FIG. 3B, in the normal direction Z of the substrate 11, the third part 121A of the first common electrode line 121 and the first part 181A of the second common electrode line 181 are at least partially overlapped.

In one embodiment of the present disclosure, as shown in FIG. 3A and FIG. 3D, the substrate structure 1 may further comprise a pixel electrode 15, and at least part of the pixel electrode 15 is disposed on the second conductive layer 18. In the normal direction Z of the substrate 11, the pixel electrode 15 and the second common electrode line 181 are partially overlapped. More specifically, in the normal direction Z of the substrate 11, the pixel electrode 15 and the first part 181A of the second common electrode line 181 are overlapped.

In one embodiment of the present disclosure, as shown in FIG. 3A and FIG. 3B, the first conductive layer 12 further comprises a gate line 122 extending along the first direction Y, wherein the gate line 122 and the first common electrode line 121 are electrically insulated. The first conductive layer 12 may further comprise a first gate electrode 123 and a second gate electrode 124 respectively extending along the second direction X, wherein the first gate electrode 123 and the second gate electrode 124 are electrically connected to the gate line 122. The gate line 122 may transmit the gate signal to the first gate electrode 123 and the second gate electrode 124. As shown in FIG. 3B, the second part 181B of the second common electrode line 181 extending along the second direction X may be arranged to cross the gate line 122.

In one embodiment of the present disclosure, as shown in FIG. 3A, FIG. 3C and FIG. 3D, the third conductive layer 17 may comprise a data line 171 extending along the second direction X. The third conductive layer 17 may further comprise a first source electrode 172, a first drain electrode 173, a second source electrode 174 and a second drain electrode 175, wherein the first source electrode 172 is electrically connected to the data line 171, and the second drain electrode 175 is electrically connected to the pixel electrode 15. The data line 171 may transmit data signals to the first source electrode 172. The third conductive layer 17 may further comprise a conductive bump 176 connecting to the second drain electrode 175. In the normal direction Z of the substrate 11, the conductive bump 176 and the third part 121A of the first common electrode line 121 are at least partially overlapped. As shown in FIG. 3A, the data line 171 extending along the second direction X may be arranged to cross the first common electrode line 121 and the gate line 122.

In one embodiment of the present disclosure, as shown in FIG. 3D, the substrate structure 1 further comprises a first semiconductor 161 and a second semiconductor 162 disposed on the first conductive layer 12, wherein the first source electrode 172 and the first drain electrode 173 are electrically connected to the first semiconductor 161, and the second source electrode 174 and the second drain electrode 175 are electrically connected to the second semiconductor 162. The first gate electrode 123, the first source electrode 172, the first drain electrode 173 and the first semiconductor 161 may form a first transistor TFT1, and the second gate electrode 124, the second source electrode 174, the second drain electrode 175 and the second semiconductor 162 may form a second transistor TFT2. In one embodiment of the present disclosure, the first transistor TFT1 may be connected in series with the second transistor TFT2. More specifically, the first drain electrode 173 may extend and connect to the second source electrode 174, thereby electrically connecting the first transistor TFT1 and the second transistor TFT2.

The transistor in FIG. 3D is only an example and the present invention is not limited thereto. According to some embodiments, the number of the transistor in the substrate structure 1 is not particularly limited, and may comprise one transistor or more than one transistor. As shown in FIG. 3D, the first conductive layer 12 (or the first gate electrode 123) is disposed between the substrate 11 and the first semiconductor 161 to form a bottom gate type transistor. According to other embodiments, even not shown in the figure, the first semiconductor 161 may be disposed between the substrate 11 and the first conductive layer 12 (or the first gate electrode 123) to form a top gate type transistor.

In one embodiment of the present disclosure, as shown in FIG. 3A and FIG. 3D, the pixel electrode 15 may be electrically connected to the second drain electrode 175 through a third via H3. More specifically, the substrate structure 1 may comprise: a first insulating layer 101 disposed on the first conductive layer 12; a second insulating layer 102 disposed on the third conductive layer 17; a third insulating layer 103 disposed on the second insulating layer 102; and a fourth insulating layer 104 disposed on the second conductive layer 18. The second insulating layer 102 comprises a via 1023, the third insulating layer 103 comprises a via 1033, the fourth insulating layer 104 comprises a via 1041, and the via 1023, the via 1033 and the via 1041 form the third via H3. The pixel electrode 15 is disposed on the fourth insulating layer 104, and the pixel electrode 15 is electrically connected to the second drain electrode 175 through the third via H3. The second conductive layer 18 is not overlapped with the third via H3. As shown in FIG. 3C and FIG. 3D, the second conductive layer 18 has a concave 183 disposed corresponding to the location of the third via H3. Thus, the pixel electrode 15 may be electrically connected to the second drain electrode 175 through the concave 183 of the second conductive layer 18. According to some embodiments, the concave 183 of the second conductive layer 18 may be overlapped with the third via H3. In the first direction Y, the width of the concave 183 of the second conductive layer 18 may be greater than the width of the third via H3. According to some embodiments, the width of the third via H3 may be the width of the bottom of the third via H3, or the width of the bottom of the via 1023 of the second insulating layer 102.

In one embodiment of the present disclosure, as shown in FIG. 3A to FIG. 3D, in the normal direction Z of the substrate 11, the first common electrode line 121 and the conductive bump 176 are partially overlapped to form a third capacitor Cst3, the conductive bump 176 and the second common electrode line 181 are partially overlapped to form a fourth capacitor Cst4, and the second common electrode line 181 and the pixel electrode 15 are partially overlapped to form a fifth capacitor Cst5. Herein, the overlapped portions of the first common electrode line 121 and the conductive bump 176 may be used as the capacitor electrodes of the third capacitor Cst3 respectively, the overlapped portions of the conductive bump 176 and the second common electrode line 181 may be used as capacitor electrodes of the fourth capacitor Cst4 respectively, and the overlapped portions of the second common electrode line 181 and the pixel electrode 15 may be used as capacitor electrodes of the fifth capacitor Cst5 respectively.

In the present disclosure, suitable material for the substrate 11 may be referred to above and is not described again here. Suitable materials for the first conductive layer 12, the second conductive layer 18 and the third conductive layer 17 may be referred to those for the first conductive layer 12 and the second conductive layer 13 as described above, and are not described again here. Suitable materials for the insulating later and the semiconductor may be referred to above and are not described again here.

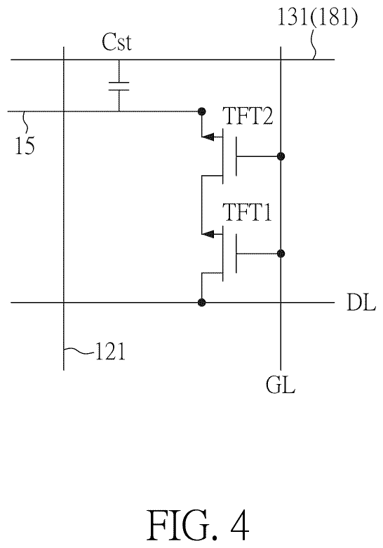

FIG. 4 is an equivalent circuit diagram according to one embodiment of the present disclosure.

In one embodiment of the present disclosure, as shown in FIG. 4, the substrate structure 1 (as shown in FIG. 1) comprises: the first transistor TFT1; the second transistor TFT2, wherein the first transistor TFT1 and the second transistor TFT2 are electrically connected; and a storage capacitor Cst. The gate line GL transmits gate signals to the first transistor TFT1 and the second transistor TFT2 to control the switch of the first transistor TFT1 and the second transistor TFT2. The data line DL transmits data signals to the pixel electrode 15 through the first transistor TFT1 and the second transistor TFT2. The first common electrode line 121 and the second common electrode lines 131, 181 receive common signals respectively.

In one embodiment of the present disclosure, when the substrate structure 1 has the structure shown in FIG. 2A to FIG. 2C, the gate line GL in the equivalent circuit diagram may be, for example, the gate line 122 shown in FIG. 2A and FIG. 2B, the data line DL in the equivalent circuit diagram may be, for example, the data line 132 shown in FIG. 2A and FIG. 2B, and the storage capacitor Cst in the equivalent circuit diagram may comprise the first capacitor Cst1 and/or the second capacitor Cst2 shown in FIG. 2C, but the present disclosure is not limited thereto.

In one embodiment of the present disclosure, when the substrate structure 1 has the structure shown in FIG. 3A to FIG. 3D, the gate line GL in the equivalent circuit diagram may be, for example, the gate line 122 shown in FIG. 3A and FIG. 3B, the data line DL in the equivalent circuit diagram may be, for example, the data line 171 shown in FIG. 3A and FIG. 3C, and the storage capacitor Cst in the equivalent circuit diagram may comprise the third capacitor Cst3, the fourth capacitor Cst4, the fifth capacitor Cst5 or a combination thereof shown in FIG. 3D, but the present disclosure is not limited thereto.

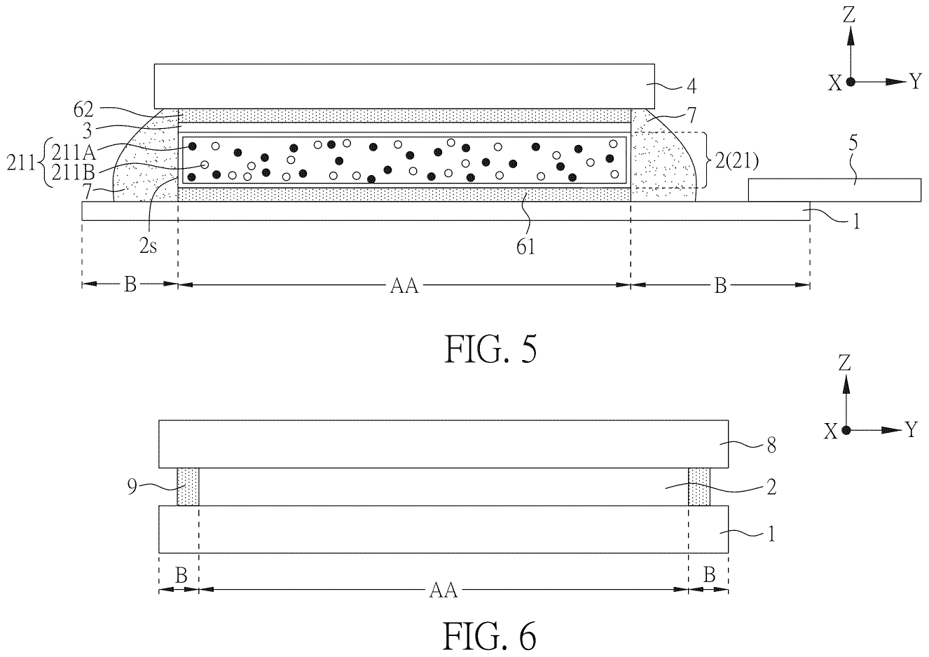

FIG. 5 is a schematic view of an electronic device according to one embodiment of the present disclosure.

In one embodiment of the present disclosure, as shown in FIG. 5, the electronic device may comprise: a substrate structure 1, a display layer 2, a common electrode layer 3 and a protection substrate 4. The substrate structure 1 comprises an active region AA and a peripheral region B disposed adjacent to the active region AA. For example, the peripheral region B may surround the active region AA. The display layer 2 is disposed on the substrate structure 1 and corresponding to the active region AA. The common electrode layer 3 is disposed on the display layer 2. The protection substrate 4 is disposed opposite to the substrate structure 1, wherein the display layer 2 and the common electrode layer 3 are disposed between the substrate structure 1 and the protection substrate 4. In the present disclosure, the detail structure of the substrate structure 1 may be referred to, for example, FIG. 1 to FIG. 3D, and is not described again here. The common electrode layer 3 may be electrically connected to the substrate structure 1 through a conductive component (not shown in the figure), thereby applying voltage to the common electrode layer 3.

In one embodiment of the present disclosure, as shown in FIG. 5, the display layer 2 may comprise an electrophoretic layer 21 comprising a plurality of charged particles 211. By applying voltage to the substrate structure 1 and the common electrode layer 3, the plurality of charged particles 211 in the electrophoretic layer 21 can be attracted or repelled, thereby achieving the effect of displaying images. Thus, in one embodiment of the present disclosure, the electronic device may be an electrophoretic display device, but the present disclosure is not limited thereto. According to some embodiments, the common signal can be transmitted to the first common electrode line 121 and the second common electrode line 131 by the circuit component 14 in FIG. 1, to apply a voltage to the substrate structure 1. In the present disclosure, the plurality of charged particles 211 may be a combination of color particles with different charges, such as a two-color particle combination of black particles and white particles with different charges; a three-color particle combination of black particles, red particles, and white particles with different charges; a four-color particle combination of black particles, red particles, yellow particles, and white particles with different charges; a four-color particle combination of blue particles, red particles, yellow particles, and white particles with different charges; or a four-color particle combination of yellow particles, cyan particles, magenta particles, and white particles with different charges, but the present disclosure is not limited thereto. The term “having different charges” may refer to having different charge polarities, having different charge magnitudes, or a combination thereof. Here, the electrophoretic layer 21 in FIG. 5 is an example of a two-color particle combination of black particles 211A and white particles 211B with different charges, but the present disclosure is not limited thereto. In one embodiment of the present disclosure, the plurality of charged particles 211 may be a two-color particle combination of black particles 211A with positive charges and white particles 211B with negative charges. In one embodiment of the present disclosure, the plurality of charged particles 211 may be a four-color particle combination of black particles with positive charges, red particles with positive charges, yellow particles with negative charges and white particles with negative charges. When the plurality of charged particles 211 are a two-color particle combination of black particles 211A and white particles 211B, the electronic device can display black and white images. When the plurality of charged particles 211 are a three-color particle combination or a four-color particle combination, the electronic device can display color images.

In the present disclosure, the common electrode layer 3 may be a whole surface common electrode layer or a patterned common electrode layer. In the present disclosure, the material of the common electrode layer 3 may comprise a transparent conductive material, such as indium zinc oxide (IZO), indium tin oxide (ITO), indium tin zinc oxide (ITZO), indium gallium zinc oxide (IGZO), aluminum zinc oxide (AZO) or a combination thereof, but the present disclosure is not limited thereto. In the present disclosure, a material similar to that of the substrate 11 can be used to prepare the protection substrate 4, and will not be described in detail here. Or, an organic polymer material may be used to prepare the protection substrate 4, such as polyimide (PI), polyethylene (PE), polyvinylchloride (PVC), polystyrene (PS), acrylic, fluoropolymer, polyester, nylon or other suitable organic material, but the present disclosure is not limited thereto.

In one embodiment of the present disclosure, as shown in FIG. 5, the electronic device may further comprise a circuit structure 5 disposed in the peripheral region B of the substrate structure 1, wherein the circuit structure 5 may be electrically connected to the components (not shown in the figure) on the substrate structure 1, thereby transmitting driving signals to the substrate structure 1. In the present disclosure, the circuit structure 5 may be, for example, a printed circuit board, a flexible printed circuit board or a combination thereof, but the present disclosure is not limited thereto.

In one embodiment of the present disclosure, as shown in FIG. 5, the electronic device may further comprise an adhesive layer 61 disposed between the substrate structure 1 and the display layer 2, thereby adhering the substrate structure 1 and the display layer 2. In one embodiment of the present disclosure, as shown in FIG. 5, the electronic device may further comprise an adhesive layer 62 disposed between the protection substrate 4 and the display layer 2, thereby adhering the protection substrate 4 and the display layer 2. In the present disclosure, the materials of the adhesive layer 61 and the adhesive layer 62 may respectively comprise glass glue, optical glue, silicone glue, adhesive tape, hot melt glue, AB glue, light curing glue, polymer glue, resin or a combination thereof, but the present disclosure is not limited thereto.

In one embodiment of the present disclosure, as shown in FIG. 5, the electronic device may further comprise a protection layer 7 disposed on the peripheral region B of the substrate structure 1 and surrounding the display layer 2. The protection layer 7 may be used to block external air or moisture from entering the display layer 2, thereby improving the reliability of the electronic device. In one embodiment of the present disclosure, as shown in FIG. 5, the protection layer 7 may contact the sides 2s of the display layer 2. In the present disclosure, the material of the protection layer 7 may comprise glass glue, optical glue, silicone glue, hot melt glue, AB glue, light curing glue, polymer glue, resin or a combination thereof, but the present disclosure is not limited thereto.

FIG. 6 is a schematic view of an electronic device according to one embodiment of the present disclosure.

In one embodiment of the present disclosure, as shown in FIG. 6, the electronic device may comprise: a substrate structure 1, a display layer 2, a counter substrate 8 and a sealant 9. The substrate structure 1 comprises an active region AA and a peripheral region B, wherein the peripheral region B may be disposed adjacent to the active region AA and, for example, the peripheral region B may surround the active region AA. The counter substrate 8 may be disposed opposite to the substrate structure 1. The display layer 2 is disposed between the substrate structure 1 and the counter substrate 8. The sealant 9 is disposed between the substrate structure 1 and the counter substrate 8 and surrounds the display layer 2. In the present disclosure, the detail structure of the substrate structure 1 may be as, for example, shown in FIG. 1 to FIG. 3D, and is not described again here. In addition, the counter substrate 8 may be prepared with similar material to the substrate 11, which is not described again here.

In one embodiment of the present disclosure, as shown in FIG. 6, the display layer 2 may comprise a liquid crystal material. Hence, in one embodiment of the present disclosure, the electronic device may be a liquid crystal display device, but the present disclosure is not limited thereto. In the present disclosure, suitable liquid crystal material may be, for example, twisted nematic liquid crystals (TN LCs), super twisted nematic liquid crystals (STN LCs), cholesteric texture liquid crystals, polymer stabilized cholesteric texture (PSCT), polymer-dispersed liquid crystals (PDLCs), polymer network liquid crystals (PNLCs), other suitable liquid crystal materials or a combination thereof, but the present disclosure is not limited thereto. Liquid crystal materials are not limited to using positive liquid crystals or negative liquid crystals. According to some embodiments, the display layer 2 may comprise liquid crystals, inorganic light emitting diodes, organic light emitting diodes or a combination thereof.

In one embodiment of the present disclosure, even not shown in the figure, the electronic device may further selectively comprise a filter layer, an alignment film, a prism, a polarizer, a reflector, a backlight module, other suitable components or a combination thereof. In one embodiment of the present disclosure, the electronic device may further comprise a touch layer (not shown in the figure); and thus, the electronic device may be a touch display device.

In the present disclosure, by disposing the first common electrode line 121 and/or the second common electrode lines 131, 181 with a special structural design, the resistance of the wiring can be reduced to achieve a stable signal transmission effect, thereby improving the display quality of the electronic device.

The above specific embodiments should be construed as merely illustrative, and not limiting of the remainder of the disclosure in any way.

Although the present disclosure has been explained in relation to its embodiment, it is to be understood that many other possible modifications and variations can be made without departing from the spirit and scope of the disclosure as hereinafter claimed.

1. An electronic device, comprising:
a substrate structure, comprising:
a substrate;
a first conductive layer disposed on the substrate and comprising a first common electrode line extending along a first direction;
a second conductive layer disposed on the first conductive layer and comprising a second common electrode line extending along a second direction different from the first direction, wherein the first common electrode line and the second common electrode line are partially overlapped in a normal direction of the substrate, wherein the second common electrode line has a first part and a second part, and a width of the first part is greater than a width of the second part in the first direction; and
a pixel electrode, wherein at least part of the pixel electrode is disposed on the second conductive layer, and the pixel electrode and the second common electrode line are partially overlapped in the normal direction of the substrate.

2. The electronic device of claim 1, wherein the first conductive layer further comprises a gate line extending along the first direction, and the gate line is electrically insulated from the first common electrode line.

3. The electronic device of claim 1, wherein the second conductive layer further comprises a data line extending along the second direction, and the data line is electrically insulated from the second common electrode line.

4. The electronic device of claim 1, wherein the substrate structure further comprises a third conductive layer, and the third conductive layer comprises a data line extending along the second direction.

5. The electronic device of claim 4, wherein the third conductive layer is disposed between the first conductive layer and the second conductive layer.

6. The electronic device of claim 5, wherein the first common electrode line has a third part and a fourth part, and a width of the third part is greater than a width of the fourth part in the second direction.

7. The electronic device of claim 6, wherein the third part of the first common electrode line and the first part of the second common electrode line are at least partially overlapped in the normal direction of the substrate.

8. The electronic device of claim 6, wherein the first common electrode line comprises a plurality of third parts and a plurality of fourth parts, and the plurality of third parts and the plurality of fourth parts alternately disposed and connected to each other.

9. The electronic device of claim 6, wherein the third conductive layer further comprises a conductive bump, and the conductive bump and the third part of the first common electrode line are at least partially overlapped.

10. The electronic device of claim 9, wherein the conductive bump and the second common electrode line are partially overlapped.

11. The electronic device of claim 1, wherein the pixel electrode and the first part of the second common electrode line are overlapped in the normal direction of the substrate.

12. The electronic device of claim 1, wherein the first common electrode line and the second part of the second common electrode line are at least partially overlapped in the normal direction of the substrate.

13. The electronic device of claim 1, further comprising a display layer disposed on the substrate structure.

14. The electronic device of claim 13, wherein the display layer comprises an electrophoretic layer comprising a plurality of charged particles.

15. The electronic device of claim 1, wherein the first conductive layer comprises a conductive bump electrically insulated from the first common electrode line.

16. The electronic device of claim 15, wherein the pixel electrode is electrically connected to the conductive bump through a first via.

17. The electronic device of claim 15, wherein the conductive bump and the second common electrode line are partially overlapped.

18. The electronic device of claim 1, wherein the pixel electrode and the second common electrode line are partially overlapped.

19. The electronic device of claim 1, wherein the second common electrode line comprises a plurality of first parts and a plurality of second parts, and the plurality of first parts and the plurality of second parts are alternately disposed and connected to each other.

20. The electronic device of claim 1, wherein the substrate structure further comprises a first semiconductor disposed on the first conductive layer.
